(19) United States
(12) Patent Application Publication
(10) Pub. No.: US 2006/0110320 A1
(43) Pub. Date: May 25, 2006

(54) Thermal spraying powder and manufacturing method thereof

(76) Inventors: Isao Aoki, Tajimi-shi (JP); Hiroyuki Ibe, Kakamigahara-shi (JP)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 11/282,250

(22) Filed: Nov. 18, 2005

(30) Foreign Application Priority Data
Nov. 22, 2004 (JP) 2004-338205

(51) Int. Cl. C01F 7/02; B05D 1/08

(52) U.S. Cl. 423/625; 427/446

(57) ABSTRACT

A thermal spraying powder contains a fused and crushed powder of alumina, and the number of colored particles included per 1 g of the thermal spraying powder is 4 or less. The thermal spraying powder is manufactured through a step for removing impurity particles from the fused and crushed powder. The step for removing impurity particles from the fused and crushed powder includes at least one of acid cleaning of the fused and crushed powder to remove metallic impurity particles from the fused and crushed powder, magnetic separation of the fused and crushed powder to remove magnetic impurity particles from the fused and crushed powder, and calcining of the fused and crushed powder to remove carbon based impurity particles from the fused and crushed powder.

### BACKGROUND OF THE INVENTION

The present invention relates to a thermal spraying powder containing a fused and crushed powder of alumina.

Semiconductor manufacturing apparatuses include members that could erode due to plasma during a plasma process. In general, most part of the semiconductor manufacturing apparatuses is formed of metal such as stainless steel and aluminum, and portions that are particularly susceptible to plasma erosion are formed of oxide ceramics such as alumina having high plasma erosion resistance. As the diameters of silicon wafers are increased, the size of the semiconductor manufacturing apparatuses has been increased. Accordingly, the size of the members formed of oxide ceramics in the semiconductor manufacturing apparatuses have been increased. However, bulk oxide ceramics manufactured through, for example, sintering is difficult to machine and the manufacturing cost is high. Therefore, as for a large-size member, an alumina coating is provided on the surface of a base material formed of metal that is relatively inexpensive and easy to machine.

A plasma spraying method is well known as one of techniques for manufacturing an alumina coating. The plasma spraying method is advantageous in that the speed for manufacturing a coating is faster than those of the physical vapor deposition method and the chemical vapor deposition method, and that the base material is not restricted. Furthermore, the physical vapor deposition method and the chemical vapor deposition method are generally performed under vacuum or reduced pressure, or in an environment where the ambient gas is controlled. Thus, the methods can only be performed in a container that produces such environments. Contrastingly, a film can be formed in the atmospheric air with the plasma spraying method, and restrictions like those of the vapor deposition methods are few.

Japanese Laid-Open Patent Publication No. 6-191836 discloses an alumina powder that can be used for forming a thermal spray coating through plasma spraying. The alumina powder is manufactured by, for example, sintering transition alumina obtained through thermal treatment of aluminum hydroxide in hydrochloric gas. Since thus manufactured alumina powder has high purity, the thermal spray coating obtained through plasma spraying of the alumina powder is useful in the semiconductor manufacturing apparatuses that should avoid contamination by impurities and particles. However, the alumina powder has a drawback that the manufacturing cost is relatively high.

As an alumina powder that requires a relatively low manufacturing cost, a fused and crushed powder of alumina widely used as raw material of the alumina thermal spray coating had been proposed before the alumina powder of the publication No. 6-191836. The alumina thermal spray coating obtained by spraying the fused and crushed powder of alumina is superior in the electrical insulation, the heat resistance, and the corrosion resistance. However, the fused and crushed powder of alumina is generally difficult to avoid contamination by impurities during manufacture. Thus, the thermal spray coating obtained through plasma spraying of the fused and crushed powder of alumina includes many colored spots generated by impurities in the fused and crushed powder. Therefore, the fused and crushed powder of alumina is believed to be unsuitable for semiconductor manufacturing apparatuses that should avoid contamination by impurities and particles.

### SUMMARY OF THE INVENTION

Accordingly, it is an objective of the present invention to improve the appearance quality of a thermal spray coating formed of a thermal spraying powder containing a fused and crushed powder of alumina.

To achieve the foregoing and other objectives of the present invention, a thermal spraying powder containing a fused and crushed powder of alumina is provided. The number of colored particles included per 1 g of the thermal spraying powder is 4 or less.

The present invention also provides a method for manufacturing a thermal spraying powder. The method includes: preparing a fused and crushed powder of alumina; and removing impurity particles from the fused and crushed powder to obtain the thermal spraying powder the number of colored particles of which included per 1 g of the thermal spraying powder is 4 or less. Removing impurity particles from the fused and crushed powder includes at least one of acid cleaning of the fused and crushed powder to remove metallic impurity particles from the fused and crushed powder, magnetic separation of the fused and crushed powder to remove magnetic impurity particles from the fused and crushed powder, and calcining of the fused and crushed powder to remove carbon based impurity particles from the fused and crushed powder.

Further, the present invention provides a method for forming a thermal spray coating. The method includes spraying the above thermal spraying powder to form the thermal spray coating.

Other aspects and advantages of the invention will become apparent from the following description illustrating by way of example the principles of the invention.

### DETAILED DESCRIPTION OF THE PREFERRED EMBODIMENTS

One embodiment of the present invention will now be described.

A thermal spraying powder of the preferred embodiment consists of a fused and crushed powder of alumina (Al₂O₃), and is used for forming a thermal spray coating through, for example, plasma spraying.

When the content of alumina in the thermal spraying powder is less than 99.90% by mass, there is a risk that the breakdown voltage (insulation resistance) of the thermal spray coating formed of the thermal spraying powder could be insufficient, and the plasma erosion resistance of the thermal spray coating could be slightly decreased. Therefore, the content of alumina in the thermal spraying powder is preferably 99.90% by mass or more.

When the content of sodium in the thermal spraying powder converted into Na₂O is more than 0.04% by mass, there is a risk that the plasma erosion resistance of the thermal spray coating formed of the thermal spraying powder could be insufficient. Therefore, the content of sodium in the thermal spraying powder converted into Na₂O is preferably 0.04% by mass or less. The content of sodium in the thermal spraying powder converted into Na₂O is measured using, for example, emission spectrometry or atomic absorption.

When the number of colored particles included per 1 g of the thermal spraying powder is more than 4, many colored spots are generated on the thermal spray coating formed of the thermal spraying powder. Thus, the appearance quality of the thermal spray coating does not satisfy the required level. Therefore, the number of the colored particles included per 1 g of the thermal spraying powder must be 4 or less. However, even if the number of the colored particles included per 1 g of the thermal spraying powder is 4 or less, when the number of the colored particles is greater than 3.5, or more specifically greater than 3, the appearance quality of the thermal spray coating formed of the thermal spraying powder is not significantly improved. Therefore, the number of the colored particles per 1 g of the thermal spraying powder is preferably 3.5 or less, and more preferably 3 or less.

The colored spots of the thermal spray coating that degrades the appearance quality of the thermal spray coating are caused not only by the colored particles in the thermal spraying powder, but also by wear debris generated by wear of apparatuses such as a powder feeder and a sprayer used during a spraying process due to the thermal spraying powder. That is, if a lot of wear debris of the powder feeder and the sprayer is mixed in the thermal spraying powder, many colored spots are generated on the thermal spray coating formed of the thermal spraying powder, thereby degrading the appearance quality of the thermal spray coating. Therefore, in view of preventing the appearance quality of the thermal spray coating from being degraded, it is important to decrease contamination of the thermal spraying powder by wear debris, in other words, to prevent wear of the powder feeder, the sprayer, and a tube that connects the powder feeder and the sprayer with each other where the thermal spraying powder contacts.

The ability of the thermal spraying powder to wear apparatuses such as the powder feeder and the sprayer is estimated based on, for example, the removal rate measured when a certain object is polished using water dispersion of the thermal spraying powder. For example, assume that the weight of borosilicate glass removed per unit time is defined as the removal rate R (unit:gram/minute) when the borosilicate glass is polished using water dispersion containing 13.6% by mass of the thermal spraying powder with the polishing load of 16.2 kPa (165 g/cm²). In this case, there is a risk that the appearance quality of the thermal spray coating could be degraded when the removal rate R is greater than a value obtained by multiplying 50% particle size D₅₀ (unit:micrometer) of the thermal spraying powder to the 0.6th power by 0.2 (that is, when R≦0.2×D₅₀ ^{0.6} is not satisfied), and more specifically, when the removal rate R is greater than a value obtained by multiplying the 50% particle size D₅₀ to the 0.6the power by 0.18 (that is, when R≦0.18×D₅₀ ^{0.6} is not satisfied), and even more specifically when the removal rate R is greater than a value obtained by multiplying the 50% particle size D₅₀ to the 0.6th power by 0.17 (that is, when R≦0.17×D₅₀^{0.6} is not satisfied). Therefore, the removal rate R is preferably less than or equal to a value obtained by multiplying the 50% particle size D₅₀ of the thermal spraying powder to the 0.6th power by 0.2, and more preferably less than or equal to a value obtained by multiplying the 50% particle size D₅₀ to the 0.6th power by 0.18, and most preferably less than or equal to a value obtained by multiplying the 50% particle size D₅₀ to the 0.6th power by 0.17. The 50% particle size D₅₀ of the thermal spraying powder is the size of the particle that is lastly summed up when the volume of particles in the thermal spraying powder is accumulated from particles of the smallest size in ascending order until the accumulated volume reaches 50% of the total volume of all the particles in the thermal spraying powder. The 50% particle size D₅₀ of the thermal spraying powder is measured using, for example, a laser diffraction/dispersion type of particle size measuring instrument.

The ability of the thermal spraying powder to wear apparatuses such as the powder feeder and the sprayer is also estimated based on the angle of repose of the thermal spraying powder. When the angle of repose of the thermal spraying powder is greater than 45 degrees, and more specifically greater than 42 degrees, there is a risk that the apparatuses such as the powder feeder and the sprayer could be significantly worn by the thermal spraying powder due to a low fluidity of the thermal spraying powder. Therefore, the angle of repose of the thermal spraying powder is preferably 45 degrees or less, and more preferably 42 degrees or less.

The ability of the thermal spraying powder to wear apparatuses such as the powder feeder and the sprayer is affected by the aspect ratio of particles in the thermal spraying powder. When the aspect ratio of particles in the thermal spraying powder is greater than 2.5, there is a risk that the apparatuses such as the powder feeder and the sprayer could be significantly worn by the thermal spraying powder since the sphericity of particles in the thermal spraying powder is low. Therefore, the aspect ratio of particles in the thermal spraying powder is preferably 2.5 or less. The aspect ratio of particles in the thermal spraying powder is the mean of the aspect ratio obtained by dividing the longitudinal diameter, which is the length of the major axis of an ellipsoid that is closest to the shape of each particle, by the lateral diameter, which is the length of the minor axis of the ellipsoid.

The ability of the thermal spraying powder to wear apparatuses such as the powder feeder and the sprayer is also affected by the circularity of the projected image of each particle in the thermal spraying powder. When the circularity of the projected image of each particle in the thermal spraying powder is less than 0.88, there is a risk that the apparatuses such as the powder feeder and the sprayer could be significantly worn by the thermal spraying powder since the sphericity of each particle in the thermal spraying powder is low. Therefore, the circularity of the projected image of each particle in the thermal spraying powder is preferably 0.88 or more. The circularity of the projected image of each particle in the thermal spraying powder is obtained by dividing the circumferential length of a circle having the same area as the projected image of the particle by the circumferential length of the projected image of the particle.

When the 50% particle size D₅₀ of the thermal spraying powder is greater than 50 μm, and more specifically greater than 45 μm, and even more specifically greater than 40 μm, there is a risk that the adhesion efficiency (spray yield) of the thermal spraying powder could be decreased. In this case, decrease of the adhesion efficiency is caused because the thermal spraying powder is not easily softened or molten by flame during spraying since the size of the particles in the thermal spraying powder is large. Therefore, in view of preventing lack of softening or melting of the thermal spraying powder, the size of the particles in the thermal spraying powder are preferably small, and more specifically, the 50% particle size D₅₀ of the thermal spraying powder is preferably 50 μm or less, and more preferably 45 μm or less, and most preferably 40 μm or less.

Contrastingly, when the 50% particle size D₅₀ of the thermal spraying powder is less than 7 μm, and more specifically less than 9 μm, and even more specifically less than 10 μm, there is a risk that pulsation could occur due to the low fluidity of the thermal spraying powder, which hinders the powder from being stably supplied to the sprayer from the powder feeder. Also, in the worst case, there is a risk that the tube that connects the powder feeder to the sprayer could be clogged with the powder, and the powder cannot be supplied to the sprayer. Furthermore, in order to efficiently supply the powder to the spray flame, the weight of the powder is preferably heavy to some extent. However, as the powder becomes finer, the weight of each powder particle is decreased. Accordingly, the powder could be hindered from being efficiently supplied to the spray flame, resulting in decrease of the adhesion efficiency. Thus, in view of preventing pulsation, clogging, and decrease of the adhesion efficiency, the 50% particle size D₅₀ of the thermal spraying powder is preferably 7 μm or more, and more preferably 9 μm or more, and most preferably 10 μm or more.

The thermal spraying powder of the preferred embodiment is manufactured in the following manner. First, raw alumina for the fused and crushed powder of alumina is manufactured through a method generally referred to as a Bayer process. In the Bayer process, alumina hydrate called bauxite is brought into solution by caustic soda. The solution is then hydrolyzed such that aluminum hydroxide precipitates out. The precipitate is filtered and washed, and then calcined to 1000° C. or more to manufacture raw alumina. Next, solidified alumina obtained by cooling raw alumina after heating to 2000° C. or more to be molten is ground to obtain the fused and crushed powder of alumina. The fused and crushed powder obtained as described above is subsequently subjected to acid cleaning, magnetic separation, and calcining. The fused and crushed powder after the calcining is cracked and classified to manufacture the thermal spraying powder.

The acid cleaning is performed to remove metallic impurity particles mixed in the fused and crushed powder that comes from, for example, a hammer used to crush solidified alumina. The magnetic separation is performed to remove magnetic impurity particles mixed in the fused and crushed powder that also comes from a hammer used to crush solidified alumina. The calcining of the fused and crushed powder is performed to remove carbon based impurity particles by sublimating or burning the carbon based impurity particles mixed in the fused and crushed powder that comes from a carbon electrode used when melting raw alumina. The calcining temperature of the fused and crushed powder is preferably 1000 to 1600° C., and more preferably 1100 to 1500° C., and the maximum temperature holding time is preferably 1 to 40 hours, and more preferably 2 to 30 hours.

The preferred embodiment has the following advantages.

The thermal spray coating obtained through plasma spraying of the thermal spraying powder according to the preferred embodiment has a sufficient appearance having small number of colored spots generated by impurities in the fused and crushed powder. Therefore, the thermal spraying powder is expected to be suitable for use in semiconductor manufacturing apparatuses in which the fused and crushed powder of alumina has been regarded unsuitable.

The preferred embodiment may be modified as follows.

The thermal spraying powder may contain components other than the fused and crushed powder of alumina. However, the content of the fused and crushed powder in the thermal spraying powder is preferably as close to 100% as possible.

A method for spraying the thermal spraying powder may be other than plasma spraying.

One or two of the acid cleaning, the magnetic separation, and the calcining during manufacture of the thermal spraying powder may be omitted.

The order of performing the acid cleaning, the magnetic separation, and the calcining is not restricted and may be performed in any order.

Next, examples and comparative examples of the preferred embodiment are explained.

In examples 1 to 13 and comparative examples 1 and 2, thermal spraying powders consisting of the fused and crushed powder of alumina were prepared. In comparative example 3, a thermal spraying powder consisting of an alumina powder disclosed in the publication No. 6-191836 was prepared. Specifics of the thermal spraying powders of examples 1 to 13 and comparative examples 1 to 3 are as shown in Table 1.

Numerical values in the column entitled “50% particle size D₅₀” in Table 1 represent the 50% particle size D₅₀ Of each thermal spraying powder measured using a laser diffraction/dispersion type of particle size distribution measuring instrument “LA-300” manufactured by HORIBA Ltd.

Numerical values in the column entitled “Density of colored particles” in Table 1 represent the number of colored particles included per 1 g of each thermal spraying powder measured using an optical microscope at a magnification of 100 times. When the observation image of the optical microscope is converted to a 256 grayscale image, particles in the thermal spraying powder having the average luminance of 100 or less were counted as the colored particles.

Numerical values in the column entitled “Removal rate” in Table 1 represent the mean of the removal rate defined as the weight of the borosilicate glass removed per unit time when the borosilicate glass (optical glass BK7) is polished in accordance with polishing conditions shown in Table 2 using water dispersion containing 13.6% by mass of each thermal spraying powder. The removal rate was calculated by dividing the difference between the weights of the borosilicate glass measured before and after polishing using an electronic balance “EB-330H” manufactured by Shimadzu Corporation by the polishing time.

Numerical values in the column entitled “Aspect ratio” in Table 1 represent the mean of the aspect ratio calculated based on the longitudinal diameters and the lateral diameters of particles in each thermal spraying powder measured using a scanning electron microscope. The calculation of the aspect ratio was performed on 100 particles arbitrarily selected from each thermal spraying powder.

Numerical values in the column entitled “Circularity” in Table 1 represent the mean of the circularity of the projected images of particles in each thermal spraying powder measured using a flow particle image analyzer “FPIA-2000” manufactured by Sysmex Corporation.

Numerical values in the column entitled “Angle of repose” in Table 1 represent the angle of repose of each thermal spraying powder measured using A.B.D-powder characteristic measuring instrument “A.B.D-72 model” manufactured by Tsutsui Rikagaku Kikai Co., Ltd.

Numerical values in the column entitled “Content of Na₂O” in Table 1 represent the content of sodium in each thermal spraying powder converted into Na₂O measured using an X-ray fluorescence analyzer.

Numerical values in the column entitled “Content of alumina” in Table 1 represent the content of alumina (alumina purity) in each thermal spraying powder calculated in accordance with the following expression 1.
content of alumina [mass %]=100−(content of Na₂O [mass %]+content of SiO₂ [mass %]+content of Fe₂O₃ [mass %]) Expression 1

In the expression 1, the content of Na₂O represents the content of sodium (Na) in the thermal spraying powder when sodium is converted into Na₂O, the content of SiO₂ represents the content of silicon (Si) in the thermal spraying powder when silicon is converted into SiO₂, and the content of Fe₂O₃ represents the content of iron (Fe) in the thermal spraying powder when iron is converted into Fe₂O₃. The content of Na₂O, the content of SiO₂, and the content of Fe₂O₃ were measured using the X-ray fluorescence analyzer.

The surface of the thermal spray coating formed through plasma spraying of each of the thermal spraying powders according to examples 1 to 13 and comparative examples 1 to 3 under conditions shown in Table 3 was observed at 50 arbitrary points using an optical microscope at a magnification of 100 times. When 50 observation images of the optical microscope were converted to 256 grayscale images, the areas of the thermal spray coating where the minimum luminance was 100 or less and the diameter was 30 μm or more were counted as colored spots. Then, based on the number of the colored spots per 1 cm² of the thermal spray coating, the thermal spray coatings were evaluated according to a four rank scale: excellent (1), good (2), acceptable (3), poor (4). That is, when the number of the colored spots per 1 cm² of the thermal spray coating was less than 0.3, the thermal spray coating was ranked excellent, when 0.3 or more and less than 0.37, the thermal spray coating was ranked good, when 0.37 or more and less than 0.45, the thermal spray coating was ranked acceptable, and when 0.45 or more, the thermal spray coating was ranked poor. The evaluation results are shown in the column entitled “Colored spots” in Table 1.

The luminance (L), the hue (a), and the chroma (b) of the surface of the thermal spray coating formed through plasma spraying of each of the thermal spraying powders according to examples 1 to 13 and comparative examples 1 to 3 was measured using a Hunter color and color difference meter (refer to JIS P8123), and the degree of whiteness of the thermal spray coating was calculated in accordance with the following expression 2. Based on the calculated degree of whiteness, the thermal spray coatings were evaluated according to a four rank scale: excellent (1), good (2), acceptable (3), poor (4). That is, when the degree of whiteness is 80% or more, the thermal spray coating was ranked excellent, when 75% or more and less than 80%, the thermal spray coating was ranked good, when 70% or more and less than 75%, the thermal spray coating was ranked acceptable, and when less than 70%, the thermal spray coating was ranked poor. The evaluation results are shown in the column entitled “Degree of whiteness” in Table 1.
degree of whiteness (%)=100−sqr((100−L)²+a²+b²) Expression 2

The thermal spray coatings formed through plasma spraying of the thermal spraying powders according to examples 1 to 13 and comparative examples 1 to 3 were subjected to 24 hours of salt spray test (refer to JIS Z2371), and the degree of whiteness of the thermal spray coatings were thereafter calculated in the same manner as described above. Based on the calculated degree of whiteness, the thermal spray coatings were evaluated according to a four rank scale: excellent (1), good (2), acceptable (3), and poor (4). That is, when the degree of whiteness is 80% or more, the thermal spray coating was ranked excellent, when 75% or more and less than 80%, the thermal spray coating was ranked good, when 70% or more and less than 75%, the thermal spray coating was ranked acceptable, and when less than 70%, the thermal spray coating was ranked poor. The evaluation results are shown in the column entitled “Degree of whiteness after salt spray test” in Table 1.

TABLE 1

| | | Density of | | | | | | | | | |
|---|---|---|---|---|---|---|---|---|---|---|---|
| | | colored | | | | | | | | | |
| | 50% | particles | | | | | Content | Content of | | | Degree of |
| | particle | [number of | Removal | | | Angle of | of NA₂O | alumina | | | whiteness |
| | size D₅₀ | colored | rate | Aspect | | repose | [mass | [mass | Colored | Degree of | after salt |
| | [μm] | particles/g] | [g/minute] | ratio | Circularity | [degrees] | percentage] | percentage] | spots | whiteness | spray test |
| Ex. 1 | 23.5 | 2.0 | 1.05 | 1.7 | 0.905 | 32.0 | 0.02% | 99.92% | 1 | 1 | 1 |
| Ex. 2 | 19.8 | 3.0 | 1.00 | 1.9 | 0.912 | 35.0 | 0.01% | 99.94% | 1 | 1 | 1 |
| Ex. 3 | 29.2 | 1.8 | 1.26 | 2.1 | 0.897 | 31.0 | 0.02% | 99.94% | 1 | 1 | 1 |
| Ex. 4 | 36.4 | 3.2 | 1.43 | 1.5 | 0.889 | 33.0 | 0.02% | 99.93% | 1 | 1 | 2 |
| Ex. 5 | 18.2 | 2.4 | 0.90 | 1.8 | 0.916 | 37.0 | 0.02% | 99.95% | 1 | 1 | 1 |
| Ex. 6 | 8.0 | 2.2 | 0.58 | 2.1 | 0.922 | 44.0 | 0.04% | 99.92% | 1 | 1 | 2 |
| Ex. 7 | 6.6 | 2.6 | 0.49 | 2.2 | 0.938 | 46.0 | 0.04% | 99.92% | 2 | 1 | 2 |
| Ex. 8 | 23.4 | 3.6 | 1.13 | 1.9 | 0.902 | 35.0 | 0.03% | 99.94% | 3 | 3 | 3 |
| Ex. 9 | 22.9 | 3.8 | 1.45 | 1.7 | 0.907 | 38.0 | 0.02% | 99.91% | 3 | 2 | 3 |
| Ex. 10 | 23.5 | 1.8 | 1.05 | 2.6 | 0.896 | 47.0 | 0.04% | 99.93% | 3 | 1 | 2 |
| Ex. 11 | 51.0 | 2.2 | 1.74 | 2.2 | 0.904 | 34.0 | 0.03% | 99.91% | 2 | 2 | 3 |
| Ex. 12 | 26.5 | 1.6 | 1.49 | 2.7 | 0.876 | 46.0 | 0.05% | 99.98% | 2 | 3 | 3 |
| Ex. 13 | 26.6 | 2.0 | 1.52 | 3.2 | 0.867 | 35.0 | 0.03% | 99.93% | 3 | 2 | 2 |
| C. Ex. 1 | 20.8 | 4.6 | 1.15 | 2.2 | 0.897 | 38.0 | 0.03% | 99.93% | 4 | 3 | 4 |
| C. Ex. 2 | 21.6 | 4.2 | 1.34 | 1.7 | 0.901 | 36.0 | 0.06% | 99.88% | 4 | 4 | 4 |
| C. Ex. 3 | 18.6 | 2.2 | 0.98 | 1.1 | 0.941 | 37.2 | 0.01% | 99.97% | 1 | 1 | 1 |

TABLE 2
Object to be polished: optical glass BK7 having a diameter of 2.5
inches (approximately 64 mm)
Polishing machine: lapping machine “HAMAI 4BT” manufactured by
HAMAI CO., LTD.
Rotation speed of surface plate: 58 rpm
Polishing load: 16.2 kPa
Polishing time: 15 minutes

TABLE 3
Base material: aluminum plate (250 mm × 75 mm × 3 mm) that has
been blast finished using a brown alumina abrasive (A#40)
Sprayer: “SG-100” manufactured by Praxair
Powder feeder: “Model 1264” manufactured by Praxair
Ar gas pressure: 50 psi
He gas pressure: 50 psi
Voltage: 37.0 V
Current: 900 A
Spraying distance: 120 mm
Feed rate of powders: 20 g/minute

As shown in Table 1, any of the evaluations for colored spots in examples 1 to 13 was either acceptable, good, or excellent, and in examples 1 to 6, in particular, the evaluations were excellent as in comparative examples 3 in which the alumina powder disclosed in the publication No. 6-191836 was used. The results suggest that the thermal spray coatings having reliable appearance quality can be formed with the thermal spraying powders of examples 1 to 13. In particular, the thermal spray coatings having the appearance quality equivalent to that of the thermal spray coating formed of the alumina powder disclosed in the publication No. 6-191836 can be formed with the thermal spraying powders of examples 1 to 6 at a low cost. Furthermore, the degree of whiteness after the salt spray test in any of examples 1 to 13 was not decreased significantly from the degree of whiteness before the salt spray test, and any of the evaluations for the degree of whiteness after the salt spray test was either acceptable, good, or excellent. The results suggest that the thermal spray powders formed of the thermal spraying powders of examples 1 to 13 contain a very small amount of iron based impurities.

1. A thermal spraying powder comprising a fused and crushed powder of alumina, wherein the number of colored particles included per 1 g of the thermal spraying powder is 4 or less.

2. The thermal spraying powder according to claim 1, wherein, if the weight of borosilicate glass removed per unit time is defined as the removal rate R (unit:gram/minute) when the borosilicate glass is polished using water dispersion containing 13.6% by mass of the thermal spraying powder with the polishing load of 16.2 kPa, the following inequality is satisfied:
R≦0.2×D₅₀ ^{0.6}
wherein D₅₀ in the inequality means 50% particle size (unit:micrometer) of the thermal spraying powder.

3. The thermal spraying powder according to claim 1, wherein the angle of repose of the thermal spraying powder is 45 degrees or less.

4. The thermal spraying powder according to claim 1, wherein the aspect ratio of particles in the thermal spraying powder is 2.5 or less.

5. The thermal spraying powder according to claim 1, wherein the circularity of a projected image of each particle in the thermal spraying powder is 0.88 or more.

6. The thermal spraying powder according to claim 1, wherein 50% particle size of the thermal spraying powder is preferably 50 μm or less.

7. The thermal spraying powder according to claim 1, wherein 50% particle size of the thermal spraying powder is preferably 7 μm or more.

8. The thermal spraying powder according to claim 1, wherein the content of alumina in the thermal spraying powder is 99.90% by mass or more.

9. The thermal spraying powder according to claim 1, wherein the content of sodium in the thermal spraying powder converted into Na₂O is 0.04% by mass or less.

10. A method for manufacturing a thermal spraying powder, comprising:
preparing a fused and crushed powder of alumina; and
removing impurity particles from the fused and crushed powder to obtain the thermal spraying powder the number of colored particles of which included per 1 g of the thermal spraying powder is 4 or less,
wherein said removing impurity particles from the fused and crushed powder includes at least one of acid cleaning of the fused and crushed powder to remove metallic impurity particles from the fused and crushed powder, magnetic separation of the fused and crushed powder to remove magnetic impurity particles from the fused and crushed powder, and calcining of the fused and crushed powder to remove carbon based impurity particles from the fused and crushed powder.

11. A method for forming a thermal spray coating, comprising spraying a thermal spraying powder to form the thermal spray coating, wherein the thermal spraying powder contains a fused and crushed powder of alumina, and the number of colored particles included per 1 g of the thermal spraying powder is 4 or less.
